(19) United States
(12) Patent Application Publication
(10) Pub. No.: US 2024/0421483 A1
(43) Pub. Date: Dec. 19, 2024

(54) SPRING MEMBER FOR ANTENNA CONTACT

(71) Applicant: PLUME DESIGN, INC., Palo Alto, CA (US)

(72) Inventors: Ming-Tsung SU, Taipei City (TW); Miroslav SAMARDZIJA, Mountain View, CA (US)

(21) Appl. No.: 18/335,222

(22) Filed: Jun. 15, 2023

(51) Int. Cl. H01Q 5/50; H01Q 3/02

(52) U.S. Cl. CPC H01Q 5/50; H01Q 3/02

(57) ABSTRACT

A device, such as a spring member, for electrically connecting an antenna to an electrical PCB may include a first arm extending on a first plane, a second arm extending on a second plane offset from the first plane, and a central portion including a flexible transition portion integrally connecting the first arm to the second arm, the central portion configured to flexibly transition between a first state and a second state responsive to a compressive force applied to the first arm towards a direction of the second arm. The spring member defines a substantially U-shaped short signal path between the first arm and the second arm, which is formed by the first arm, second arm, and the central portion. The spring member may include a height of approximately 1.2 mm and the spring member may deflect by 0.6 mm in response to a certain compressive force being applied thereto.

### FIELD

The present disclosure relates to the field of antenna. More particularly, to electrical contact spring members for antenna.

### BACKGROUND

Antennas are commonly used in different types of electronic devices for transmitting and/or receiving electromagnetic fields (or signals) such as, for example, radio waves, microwaves, infrared radiation (IR), and visible light. The antenna acts as a transducer and converts electric current signals into electromagnetic waves or vice versa. A controller, or other electronic circuit board, may be in electrical communicable connection with the antenna for sending and receiving the electric current signal. The antenna may be connected to the controller, or board, at an electrical terminal of the board.

### SUMMARY

Placing an antenna in electrically communicable contact with the controller, or other electronic programmable circuit board (PCB) poses certain challenges related to the physical dimensions, compression elasticity, signal path between the controller and antenna, and other challenges. These limitations can affect the quality of the electrical connection between the controller and thereby affects antenna performance. For example, poor connectivity caused by an inadequate electrical connection at the connection point between the antenna and the controller may result in signal degradation or signal loss.

Some approaches as known in the prior art may solder the antenna, or electrical conductor associated therewith, directly onto the PCB or electrical conductor. Other approaches as known in the prior art may include an electrical connector for connecting the antenna to the controller, or other PCB. However, these approaches pose additional constraints when designing electrical devices as adequate space may need to be provided for accommodating the additional hardware and for allowing adequate space for the antenna to be connected/disconnected to the controller during installation and repair. For example, the device may need to be substantially disassembled to replace an antenna soldered onto a controller due to the design of the device or available space at the connection location on the controller. Accordingly, these approaches may pose problems if the antenna or the controller board needs to be replaced post-assembly.

Various embodiments of the present disclosure relate to a spring member for an antenna. The spring member may be configured to undergo elastic deformation in response to a load being applied to it, and in which the spring member may return to its original shape after the load is removed. Accordingly, the spring member may include a shape to provide compression elasticity, which enables the spring member to withstand a certain amount of compression force and compress to within a certain range for providing adequate electrical contact between the antenna and the electrical PCB (e.g., controller), as will be further described herein. Additionally, the dimensions and shape of the spring member of the present disclosure may be configured to provide a short signal loop path through the spring member for providing improved antenna performance by limiting signal losses as the electrical current passes through the spring member.

In some embodiments, a spring member forming an electrical contact, the spring member includes a first arm, the first arm extending on a first plane, a second arm, the second arm extending on a second plane offset from the first plane, a central portion including a flexible transition portion integrally connecting the first arm to the second arm, the central portion configured to flexibly transition between a first state and a second state responsive to a compressive force applied to the first arm towards a direction of the second arm, and the spring member defining a substantially U-shaped short signal path between the first arm and the second arm.

In some embodiments, the first arm includes a flared tip, the flared tip being located at a distal end of the first arm and being configured to contact an antenna applying the compressive force to the first arm, and the spring member forms an antenna signal loop between the antenna and a PCB responsive to the electrical contact being positioned therebetween.

In some embodiments, the second arm being configured to be fixedly connected to an electrical terminal by a fastener.

In some embodiments, the second arm including a solder pad, the second arm being fixedly connected to the electrical terminal by solder.

In some embodiments, the spring member further including a divider, the divider extending across a width of the spring member and defining a solder pad at the second arm, and the divider being configured to prevent solder applied to the solder pad from collecting at the central portion and affecting a tensioning performance of the spring member.

In some embodiments, an angular relationship between the first arm and the second arm decreases responsive to the compressive force applied to the first arm.

In some embodiments, a length between a first end and a second end being less than 2 mm, and a height between the first arm and the second arm with no load applied to the first arm being approximately 1.2 mm.

In some embodiments, the length between the first end and the second end includes a distance of 1.95 mm.

In some embodiments, a deflection distance between the first state and the second state being proportional to the compressive force.

In some embodiments, the deflection distance being approximately 0.6 mm.

In some embodiments, the deflection distance between the first state and the second state being approximately 0.6 mm responsive to the compressive force being approximately 1.15 N.

In some embodiments, a spring member, the deflection distance being based on a yield stress of approximately 1110 mPa being applied to the central portion.

In some embodiments, a device including a first arm, the first arm extending on a first plane, a second arm, the second arm extending on a second plane offset from the first plane, a central portion including a flexible transition portion integrally connecting the first arm to the second arm, the central portion configured to flexibly transition between a first state and a second state responsive to a compressive force applied to the first arm towards a direction of the second arm, a flared tip, the flared tip being located at a distal end of the first arm and being configured to contact an electrical element applying the compressive force to the first arm, and the first arm, second arm, and central portion defining a substantially U-shaped short signal path between the first arm and the second arm.

In some embodiments, the second arm including a solder pad, the second arm being configured to fixedly connect to an electrical terminal by solder.

In some embodiments, the device further including a divider, the divider extending across a width of the device and defining a solder pad at the second arm, and the divider being configured to prevent solder applied to the solder pad from collecting at the central portion and affecting a tensioning performance of the device.

In some embodiments, an angular relationship between the first arm and the second arm decreases responsive to the compressive force applied to the first arm.

In some embodiments, a length between a first end and a second end of the device being approximately 1.95 mm, and a height between the first arm and the second arm with no load applied to the first arm being approximately 1.2 mm.

In some embodiments, a deflection distance between the first state and the second state being proportional to the compressive force, and a height between the first arm and the second arm with a compressive force applied to the first arm being approximately 0.6 mm.

In some embodiments, a device, the deflection distance between the first state and the second state being responsive to the compressive force of approximately 1.15 N.

In some embodiments, a system including an antenna, an electrical circuit board, and an electrically conductive spring member located between the antenna and the electrical circuit board, the spring member including a first arm extending on a first plane, a second arm, the second arm extending on a second plane offset from the first plane, a central portion including a flexible transition portion integrally connecting the first arm to the second arm, the central portion configured to flexibly transition between a first state and a second state responsive to a compressive force applied to the first arm towards a direction of the second arm, a solder pad, the second arm being configured to be fixedly connected to the electrical circuit board using solder, a divider, the divider extending across a width of the spring member and defining the solder pad from the central portion, the spring member defining a U-shaped short signal path between the antenna and the electrical circuit board, and a deflection distance between the first state and the second state being proportional to the compressive force applied thereto such that an angular relationship between the first arm and the second arm decreases responsive to the compressive force applied to the first arm, the deflection distance being approximately 0.6 mm in response to the compressive force of approximately 1.15 N.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view of a non-limiting example of a spring member, according to some embodiments.

FIG. 2 is a second perspective view of the spring member, according to some embodiments.

FIG. 3 is a bottom view of the spring member, according to some embodiments.

FIG. 4 is a side view of the spring member, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

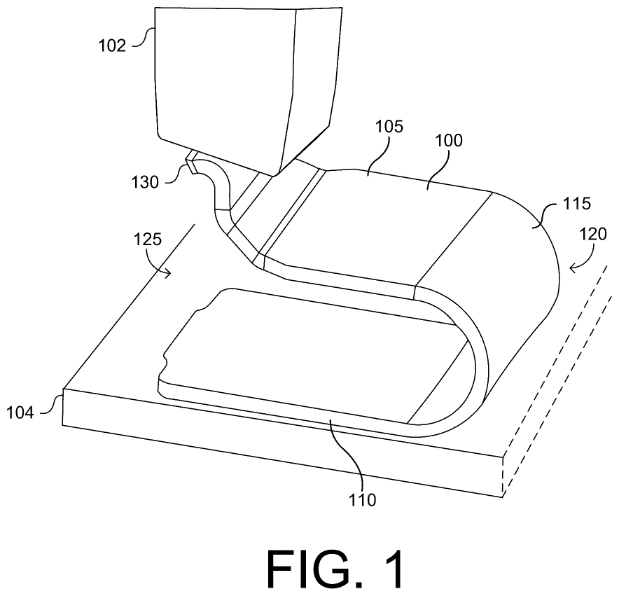

FIG. 1 is a perspective view of a spring member 100, according to some embodiments.

Spring member 100 may be positioned between an antenna 102 and an electronic PCB 104, thereby placing the antenna 102 in electrically communicable connection with the PCB 104 for transmitting and receiving electric current signals between the antenna 102 and the PCB 104. In this regard, the spring member 100 may be made of electrically conductive materials having certain compression elasticity characteristics capable of providing a secured electrical connection between the antenna 102 and the PCB 104, while also allowing the electric current signals to pass through the spring member 100 between the antenna 102 and the PCB 104. However, it is to be appreciated by those having ordinary skill in the art that the type of material used to form the spring member 100 is not intended to be limiting and may include any of a plurality of electrically conductive materials including, but not limited to, copper, gold, aluminum, silver, platinum, stainless steel, other metals, alloys thereof, or any combinations thereof.

Spring member 100 may include a first arm 105 and a second arm 110. The first arm 105 may be configured to contact an antenna, and the second arm 110 may be configured to contact the electronic PCB. The first arm 105 and the second arm 110 may be elongate contact arms for contacting an antenna and an electronic PCB, respectively, in some embodiments.

The first arm 105 may extend on a first plane and the second arm 110 may extend on a second plane. The first arm 105 may be configured to contact the antenna 102 and the second arm 110 may be configured to contact the PCB 104. In some embodiments, the first plane of the first arm 105 and the second plane of the second arm 110 may be offset relative to each other. Additionally, the first plane may also be parallel relative to the second plane when the spring member 100 is not under compression, in some embodiments. In other embodiments, the first plane and the second plane may extend on different planes that may be oriented such that the respective planes intersect when the spring member 100 is not under compression.

The first arm 105 may include a tip 130, in some embodiments. The tip 130 may be located at a distal end of the first arm 105 opposite the central portion 115, the tip 130 being configured to contact the antenna 102 applying a compressive force to the first arm 105 and the spring member 100. The spring member 100 thereby forms an antenna signal loop between the antenna 102 and the PCB 104, the antenna signal loop thereby further being defined by the tip 130. In some embodiments, the tip 130 may be flared and the antenna 102 may be configured to contact the first arm 105 at the tip 130 to improve the connection between the spring member 100 and the antenna 102 and to enable the antenna 102 to apply adequate compressive force onto the first arm 105 and the spring member 100.

The second arm 110 may be configured to connected to the PCB 104 by a fastener. In some embodiments, the second arm 110 may be configured to be fixedly connected to the PCB 104. For example, in some embodiments, the second arm 110 may be coupled to the PCB 104 by being soldered onto the PCB 104. In this regard, the second arm 110 may include a solder pad 112. Accordingly, the second arm 110 may be fixedly connected to an electrical terminal of the PCB 104 by being soldered onto the PCB 104. This enables the antenna 102 to be installed/uninstalled from a device having the antenna 102 and the PCB 104 installed therein and thereby enables the antenna 102 to be connected/disconnected from the PCB by removing the entire antenna 102 (or antenna assembly) without having to disconnect any other intermediate components that may be mechanically coupling the antenna 102 to the PCB 104.

The spring member 100 may include a central portion 115 located between the first arm 105 and the second arm 110. The central portion 115 may be a flexible portion integrally connecting the first elongate contact arm to the second elongate contact arm. In this regard, the central portion 115 may serve as the spring arm of the spring member 100, the central portion 115 being configured to flexibly transition between a first state (e.g., first position) and a second state (e.g., second position) responsive to a compressive force applied to the spring member 100. Accordingly, in response to the compressive force applied to the spring member 100, the central portion 115 bends, thereby enabling the first arm 105 to move towards the second arm 110. The spring member 100 may have a U-shape defined by the first arm 105, the second arm 110, and the central portion 115. When installed between the antenna 102 and PCB 104, the shape of the spring member 100 thereby provides a shorten signal path between the antenna 102 and PCB 104 for providing improved signal conduction, such as compared to when an electrical conductor is installed therebetween.

The central portion 115 may be located at a first end 120 of the spring member 100 and the first arm 105 and second arm 110 may extend from the central portion 115 and the first end 120 towards a second end 125 opposite the first end 120. In some embodiments, the first arm 105 and second arm 110 may extend from the central portion 115 towards the second end 125 in a similar direction. In some embodiments, the first arm 105 and second arm 110 may extend from the central portion 115 towards the second end 125 in a substantially similar direction. In other embodiments, the first arm 105 may extend from the central portion 115 towards the second end 125 in a first direction (e.g., first plane) and the second arm 110 may extend from the central portion 115 towards the second end 125 in a second direction (e.g., second plane).

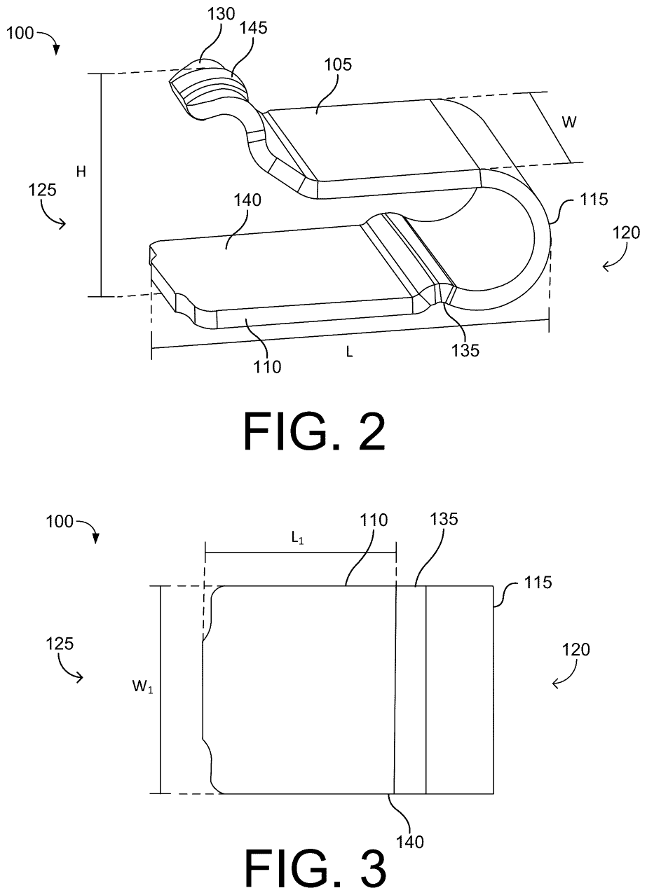

FIG. 2 is a second perspective view of the spring member 100, according to some embodiments. FIG. 3 is a bottom view of the spring member 100, according to some embodiments. Unless specifically referenced, FIGS. 2 and 3 will be described collectively.

Referring to FIG. 2, the size and shape of the spring member 100 may be such that the spring member 100 may connect antenna 102 to PCB 104 while overcoming the challenges posed by the physical limitations associated with having such dimensions, while still being capable of reliably connecting the antenna 102 to the PCB 104. The antenna 102 having a tip similar in size to the spring member 100.

In this regard, spring member 100 may include dimensions having a width W, length L, and a height H. In some embodiments, the width W of the spring member 100 may be 2 mm or less. In some embodiments, the width W of the spring member 100 may be approximately 1.5 mm. In a preferred embodiments, the width W of the spring member 100 may be 1.5 mm.

In some embodiments, the length L of the spring member 100 may be 2 mm or less. In some embodiments, the length L of the spring member 100 may be approximately 2 mm. In a preferred embodiments, the length L of the spring member 100 may be 1.95 mm.

In some embodiments, the height H of the spring member 100 may be 2 mm or less when the spring member 100 is not under a compressive force. In some embodiments, the height H of the spring member 100 may be approximately 1.2 mm when the spring member 100 is not under a compressive force. In a preferred embodiments, the width W of the spring member 100 may be 1.2 mm when the spring member 100 is not under a compressive force. However, the height H of the spring member 100 may increase or decrease in response to a compressive force, as will be further described herein.

The spring member 100 may include an embossment 145 at the distal end of the first arm 105, e.g., at tip 130, configured to contact an end of the antenna 102. When the antenna 102 applies a compressive force onto the spring member 100, the end of the antenna 102 contacts the embossment 145 and the spring member 100 is tensioned in response to the compressive force. In this regard, the embossment 145 may act in cooperation with the central portion 115 to place the antenna 102 in connection with the PCB 104.

The spring member 100 may include a divider 135. The divider 135 may be a raised segment on the spring member 100 which thereby forms a physical divide between the second arm 110 and the central portion 115. Additionally, the divider 135 may define a solder pad 140 at the second arm 110 for receiving a solder material thereon to fixedly attach the spring member 100 to the PCB 104. The divider 135 may also be configured to limit or prevent solder material being applied at the second arm 110 at the solder pad 140 in its liquid state from spreading and collecting onto the central portion 115, thereby limiting solder material from solidifying at the central portion 115 and affecting a tensioning performance of the spring member 100. The divider 135 may extend across a width W of the spring member 100.

Referring to FIG. 3, the solder pad 140 at the second arm 110 may be defined as having dimensions including a width W₁ and a length L₁. The width W₁ may be substantially similar to a width W of the spring member 100, as shown in FIG. 2. Additionally, the length L₁ of the solder pad 140 may be substantially similar to the distance between the divider 135 and the distal end of the second arm 110. In some embodiments, the dimensions of the solder pad 140 may vary based on the available physical dimensions at the PCB 104. In some embodiments, each of the width W₁ and the length L₁ of the solder pad 140 may be less than 5 mm. In some embodiments, each of the width W₁ and the length L₁ of the solder pad 140 may be less than 4 mm. In some embodiments, each of the width W₁ and the length L₁ of the solder pad 140 may be less than 3 mm. In other embodiments, each of the width W₁ and the length L₁ of the solder pad 140 may be less than 2 mm. In some embodiments, each of the width W₁ and the length L₁ of the solder pad 140 may include a range from 1 mm to 2 mm. In some embodiments, each of the width W₁ and the length L₁ of the solder pad 140 may be less than 1 mm. In a preferred embodiment, the solder pad 140 may have a width W₁ of 1.3 mm and a length L₁ of 1.2 mm.

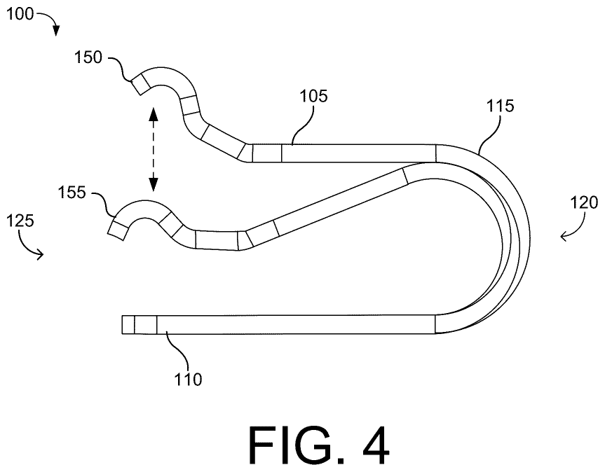

FIG. 4 is a side view of the spring member 100, according to some embodiments.

Referring to FIG. 4, the spring member 100 may move between a first position 150 and a second position 155. The spring member 100 may be in the first position 150 when no compressive force is applied to the spring member 100 and the first arm 105. Additionally, the spring member 100 may be in the second position 155 in response to a certain compressive force applied to the spring member 100 and the first arm 105. In this regard, a deflection distance between the first position 150 and the second position 155 for the spring member 100 may be proportional to the compressive force being applied thereto, in some embodiments.

When the certain compressive force is applied to the spring member 100, tension is applied to the central portion 115 and the first arm 105 moves in a downward direction towards the second arm 110 in response to the compressive force. When the compressive force is removed from the spring member 100, the tension is removed from the central portion 115 and the central portion 115 relaxes and returns to its original position, which then enables the first arm 105 to move in an upward direction away from the second arm 110. In this regard, in some embodiments, in response to a compressive force, the angular relationship between the first arm 105 and the second arm 110 may increase or decrease corresponding to the amount of compressive force being applied to the spring member 100. In some embodiments, the angular relationship between the first arm 105 and second arm 110 decreases responsive to the compressive force applied to the first arm 105. Additionally, in some embodiments, the angular relationship between the first arm 105 and second arm 110 increases responsive to the compressive force being removed from the first arm 105 until the central portion 115 returns to its original relaxed state.

Correspondingly, the spring member 100 and the central portion 115 may include characteristics such that the height H of the spring member 100, or the distance between the first arm 105 and second arm 110 when moving between the first position 150 and second position 155 (e.g., displacement), may vary in response to a certain compressive force being applied to the spring member 100. In this regard, the spring member 100 may be designed such that the spring member 100 may withstand a certain amount of compressive force without the first arm 105 being displaced to an extent that the first arm 105 comes directly into contact with the second arm 110, thereby interrupting the signal loop formed by the first arm 105, second arm 110, and central portion 115.

The spring member 100, e.g., the central portion 115, may also be capable of withstanding a certain amount of compressive force without exceeding the elastic limit of the spring member 100, and thereby undergoing permanent mechanical deformation, while also being able to return to the first position 150 in response to the compressive force being removed. For example, the central portion 115 may include a yield stress of approximately 1110 Mpa at the central portion 115, which displaces the first arm 105 by a height equal to 0.6 mm in response to the stress, in some embodiments. In some embodiments, the spring member 100 may receive approximately 1.15 N of compression force. In some embodiments, the spring member 100 may include a height H of 1.2 mm and be displaced by a height equal to 0.6 mm in response to 1.15 N of compression force. In other embodiments, the spring member 100 may receive approximately 1.0 N of compression force. Additionally, in some embodiments, the spring member 100 may be displaced by 0.5 mm in response to 1.0 N of compression force.

It is to be appreciated, however, by those having ordinary skill in the art that the amount of compressive force the spring member 100 may be capable of withstanding is exemplary and not intended to be limiting. Accordingly, the spring member 100 may therefore include dimensions and characteristics which make it capable of being used for certain applications where the physical size is a limitation and where the spring member 100 may be capable of withstanding a certain amount of compressive force as applied by the antenna 102. It is also to be appreciated by those having ordinary skill in the art that the spring member 100 may be capable of withstanding additional compression force greater than 1.15 N without exceeding the elastic limit and undergoing permanent mechanical deformation, in accordance with the present disclosure.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “compression elasticity” refers to a mechanical property corresponding to the ratio of mechanical stress to strain in a spring member when the spring member is being compressed. Stated another way, it is a measure of the tensile or compressive stiffness of the spring member when force is applied thereto and quantifies the relationship between the stress σ (force per unit area) and axial strain ε (proportional deformation) in the linear elastic region of the spring member (or material of the spring member).

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or any combination(s) thereof.

What is claimed is:

1. A spring member forming an electrical contact, the spring member comprising:
a first arm comprising:
wherein the first arm extends on a first plane;
a second arm,
wherein the second arm extends on a second plane offset from the first plane;
a central portion comprising:
a flexible transition portion integrally connecting the first arm to the second arm, the central portion configured to flexibly transition between a first state and a second state responsive to a compressive force applied to the first arm towards a direction of the second arm; and
wherein the spring member defines a substantially U-shaped short signal path between the first arm and the second arm.

2. The spring member of claim 1, wherein the first arm comprises:
a flared tip,
wherein the flared tip is located at a distal end of the first arm and is configured to contact an antenna applying the compressive force to the first arm; and
wherein the spring member forms an antenna signal loop between the antenna and a PCB responsive to the electrical contact being positioned therebetween.

3. The spring member of claim 1, wherein the second arm is configured to be fixedly connected to an electrical terminal by a fastener.

4. The spring member of claim 3, wherein the second arm comprises:
a solder pad,
wherein the second arm is fixedly connected to the electrical terminal by solder.

5. The spring member of claim 1, further comprising:
a divider,
wherein the divider extends across a width of the spring member and defines a solder pad at the second arm, and the divider is configured to prevent solder applied to the solder pad from collecting at the central portion and affecting a tensioning performance of the spring member.

6. The spring member of claim 1, wherein an angular relationship between the first arm and the second arm decreases responsive to the compressive force applied to the first arm.

7. The spring member of claim 1, wherein a length between a first end and a second end is less than 2 mm, and
wherein a height between the first arm and the second arm with no load applied to the first arm is approximately 1.2 mm.

8. The spring member of claim 7, wherein the length between the first end and the second end comprises a distance of 1.95 mm.

9. The spring member of claim 1, wherein a deflection distance between the first state and the second state is proportional to the compressive force.

10. The spring member of claim 9, wherein the deflection distance is approximately 0.6 mm.

11. The spring member of claim 9, wherein the deflection distance between the first state and the second state is approximately 0.6 mm responsive to the compressive force being approximately 1.15 N.

12. The spring member of claim 9, wherein the deflection distance is based on a yield stress of approximately 1110 mPa being applied to the central portion.

13. A device comprising:
a first arm comprising:
wherein the first arm extends on a first plane;
a second arm,
wherein the second arm extends on a second plane offset from the first plane;
a central portion comprising:
a flexible transition portion integrally connecting the first arm to the second arm, the central portion configured to flexibly transition between a first state and a second state responsive to a compressive force applied to the first arm towards a direction of the second arm;
a flared tip,
wherein the flared tip is located at a distal end of the first arm and is configured to contact an electrical element applying the compressive force to the first arm; and
wherein the first arm, second arm, and central portion define a substantially U-shaped short signal path between the first arm and the second arm.

14. The device of claim 13, wherein the second arm comprises:
a solder pad,
wherein the second arm is configured to fixedly connect to an electrical terminal by solder.

15. The device of claim 13, further comprising:
a divider,
wherein the divider extends across a width of the device and defines a solder pad at the second arm, and the divider is configured to prevent solder applied to the solder pad from collecting at the central portion and affecting a tensioning performance of the device.

16. The device of claim 13, wherein an angular relationship between the first arm and the second arm decreases responsive to the compressive force applied to the first arm.

17. The device of claim 13, wherein a length between a first end and a second end of the device is approximately 1.95 mm, and
wherein a height between the first arm and the second arm with no load applied to the first arm is approximately 1.2 mm.

18. The device of claim 13, wherein a deflection distance between the first state and the second state is proportional to the compressive force, and
wherein a height between the first arm and the second arm with a compressive force applied to the first arm is approximately 0.6 mm.

19. The device of claim 18, wherein the deflection distance between the first state and the second state is responsive to the compressive force of approximately 1.15 N.

20. A system comprising:
an antenna;
an electrical circuit board; and
an electrically conductive spring member located between the antenna and the electrical circuit board, the spring member comprising:
a first arm comprising:
wherein the first arm extends on a first plane;
a second arm,
wherein the second arm extends on a second plane offset from the first plane;
a central portion comprising:
a flexible transition portion integrally connecting the first arm to the second arm, the central portion configured to flexibly transition between a first state and a second state responsive to a compressive force applied to the first arm towards a direction of the second arm;
a solder pad,
wherein the second arm is configured to be fixedly connected to the electrical circuit board using solder;
a divider,
wherein the divider extends across a width of the spring member and defines the solder pad from the central portion;
wherein the spring member defines a U-shaped short signal path between the antenna and the electrical circuit board; and
wherein a deflection distance between the first state and the second state is proportional to the compressive force applied thereto such that an angular relationship between the first arm and the second arm decreases responsive to the compressive force applied to the first arm, the deflection distance being approximately 0.6 mm in response to the compressive force of approximately 1.15 N.
